(19) United States
(12) Patent Application Publication
(10) Pub. No.: US 2022/0318135 A1
(43) Pub. Date: Oct. 6, 2022

(54) METHOD AND APPARATUS FOR PROCESSING INFORMATION AND ELECTRONIC DEVICE AND COMPUTER READABLE STORAGE MEDIUM

(71) Applicant: Rajax Network Technology (Shanghai) Co., Ltd., Shanghai (CN)

(72) Inventor: Jianfeng HU, Beijing (CN)

(21) Appl. No.: 17/763,817

(22) PCT Filed: Mar. 31, 2020
(86) PCT No.: PCT/CN2020/082455

§ 371 Date: Mar. 25, 2022

(30) Foreign Application Priority Data
Sep. 25, 2019 (CN) 201910910428.2

(51) Int. Cl. G06F 12/02; G06F 16/906

(52) U.S. Cl. CPC G06F 12/0253; G06F 16/906

(57) ABSTRACT

A method and an apparatus for processing information and an electronic device and a computer readable storage medium are provided. The method includes: obtaining information of a target task object; obtaining garbage classification information corresponding to the target task object according to the information of the target task object; displaying the garbage classification information on a task display page. Therefore, a user may be directed to carry out garbage classification, thereby improving the accuracy of garbage identification and classification.

### CROSS REFERENCE TO RELATED APPLICATIONS

The present application is a U.S. National Phase of International Application Serial No. PCT/CN2020/082455 filed on Mar. 31, 2020, which claims priority to Chinese Patent Application No. 201910910428.2 filed on Sep. 25, 2019. The entire content of the above-referenced applications is incorporated herein by reference.

### TECHNICAL FIELD

The present disclosure relates to the field of internet technologies, and in particular to a method and an apparatus for processing information, and an electronic device and a computer readable storage medium.

### BACKGROUND

Domestic garbage classification helps protect the environment. Nowadays, garbage classification is carried out in more and more regions officially. Along with fast development of internet technologies, shopping platforms and takeout platforms bring much convenience to life. However, purchases from the shopping platforms or the takeout platforms, especially purchases from the takeout platforms, are usually accompanied by many domestic garbages.

### SUMMARY

In view of this, one or more embodiments of the present disclosure provide a method and an apparatus for processing information and an electronic device and a computer readable storage medium, so as to direct a user to carry out garbage classification and improve an accuracy of garbage identification and classification.

According to a first aspect of embodiments of the present disclosure, there is provided a method of processing information. The method includes:
obtaining, by at least one processor, information of a target task object, where the information of the target task object includes a name and additional information of the target task object;
obtaining, by at least one processor, garbage classification information corresponding to the target task object according to the information of the target task object;
displaying the garbage classification information on a task display page.

In some examples, displaying the garbage classification information on the task display page includes:
in response to a garbage classification display instruction, displaying the garbage classification information on the task display page.

In some examples, obtaining, by at least one processor, the garbage classification information corresponding to the target task object according to the information of the target task object includes:
based on a pre-established garbage classification table or garbage classification model, determining the garbage classification information according to the information of the target task object;
where the garbage classification table is established based on a preset garbage classification rule according to information of historical task objects, and the garbage classification model is obtained through training according to the information of the historical task objects.

In some examples, based on the garbage classification model, determining the garbage classification information according to the information of the target task object includes:
inputting the information of the target task object into the garbage classification model to obtain raw material information and preparation information corresponding to the target task object;
according to the raw material information, the preparation information and the additional information, determining the garbage classification information.

In some examples, obtaining, by at least one processor, the garbage classification information corresponding to the target task object according to the information of the target task object includes:
sending the information of the target task object;
receiving the garbage classification information determined by a server.

In some examples, the method further includes:
receiving garbage classification, by at least one processor, feedback information;
updating the garbage classification table based on the garbage classification feedback information, and/or, adjusting an algorithm parameter of the garbage classification model based on the garbage classification feedback information.

In some examples, the method further includes:
determining a resource cost parameter corresponding to a garbage produced by the target task object;
displaying the resource cost parameter on the task display page.

In some examples, the information of the target task object further includes address information of the target task object;
obtaining, by at least one processor, the garbage classification information corresponding to the target task object according to the information of the target task object includes:
determining a corresponding garbage classification criterion according to the address information;
determining the garbage classification information of the target task object according to the garbage classification criterion.

According to a second aspect of embodiments of the present disclosure, there is provided an apparatus for processing information. The apparatus includes:
a target task object information obtaining unit, configured to obtain, by at least one processor, information of a target task object, where the information of the target task object includes a name and additional information of the target task object;
a garbage classification information obtaining unit, configured to obtain, by at least one processor, garbage classification information corresponding to the target task object according to the information of the target task object;
a displaying unit, configured to display the garbage classification information on a task display page.

According to a third aspect of embodiments of the present disclosure, there is provided an electronic device, including a memory and a processor, where the memory is configured to store one or more computer program instructions, which are executed by the processor to perform the steps of:
obtaining, by at least one processor, information of a target task object, where the information of the target task object includes a name and additional information of the target task object;
obtaining, by at least one processor, garbage classification information corresponding to the target task object according to the information of the target task object;
displaying the garbage classification information on a task display page.

In some examples, displaying the garbage classification information on the task display page includes:
in response to a garbage classification display instruction, displaying the garbage classification information on the task display page.

In some examples, obtaining, by at least one processor, the garbage classification information corresponding to the target task object according to the information of the target task object includes:
based on a pre-established garbage classification table or garbage classification model, determining the garbage classification information according to the information of the target task object;
where the garbage classification table is established based on a preset garbage classification rule according to information of historical task objects, and the garbage classification model is obtained through training according to the information of the historical task objects.

In some examples, based on the garbage classification model, determining the garbage classification information according to the information of the target task object includes:
inputting the information of the target task object into the garbage classification model to obtain raw material information and preparation information corresponding to the target task object;
according to the raw material information, the preparation information and the additional information, determining the garbage classification information.

In some examples, obtaining, by at least one processor, the garbage classification information corresponding to the target task object according to the information of the target task object includes:
sending the information of the target task object;
receiving the garbage classification information determined by a server.

In some examples, the one or more computer program instructions are executed by the processor to further perform the steps of:
receiving, by at least one processor, garbage classification feedback information;

updating the garbage classification table based on the garbage classification feedback information, and/or, adjusting an algorithm parameter of the garbage classification model based on the garbage classification feedback information.

In some examples, the one or more computer program instructions are executed by the processor to further perform the steps of:
determining a resource cost parameter corresponding to a garbage produced by the target task object;
displaying the resource cost parameter on the task display page.

In some examples, the information of the target task object further includes address information of the target task object;
obtaining, by at least one processor, the garbage classification information corresponding to the target task object according to the information of the target task object includes:
determining a corresponding garbage classification criterion according to the address information;
determining the garbage classification information of the target task object according to the garbage classification criterion.

According to a fourth aspect of embodiments of the present disclosure, there is provided a computer readable storage medium, storing one or more computer program instructions thereon, wherein the computer program instruction is executed by a processor to implement the above method.

In the embodiments of the present disclosure, after an instruction for generating a target task is received, information of a target task object is obtained, and garbage classification information corresponding to the target task object is obtained according to the information of the target task object, and then the garbage classification information is displayed on a task display page. Therefore, a user may be directed to carry out garbage classification, thus improving an accuracy of the garbage identification and classification.

### BRIEF DESCRIPTION OF THE DRAWINGS

Through the descriptions of the embodiments of the present disclosure made below by referring to the accompanying drawings, the above objects, and other objects, features and advantages of the present disclosure will become apparent.

FIG. 1 is a flowchart illustrating a method of processing information according to an embodiment of the present disclosure.

FIGS. 2 to 6 are schematic diagrams illustrating a display page according to embodiments of the present disclosure.

FIG. 7 is a flowchart illustrating another method of processing information according to embodiments of the present disclosure.

FIG. 8 is a flowchart illustrating yet another method of processing information according to an embodiment of the present disclosure.

FIG. 9 is a schematic diagram illustrating an apparatus for processing information according to an embodiment of the present disclosure.

FIG. 10 is a schematic diagram illustrating an electronic device according to an embodiment of the present disclosure.

### DETAILED DESCRIPTION OF THE EMBODIMENTS

The present disclosure is described below based on specific embodiments but not limited to these embodiments. In the following detailed descriptions of the present disclosure, some specific detail parts are elaborated. Those skilled in the art may fully understand the present disclosure without the descriptions of these detailed parts. In order to avoid confusion about the essence of the present disclosure, those well-known methods, processes, flows, elements and circuits are not detailed herein.

Furthermore, persons of ordinary skill in the part should understand that the accompanying drawings are all used for the purpose of descriptions, and are not necessarily drawn to scale.

Unless otherwise stated clearly, similar words such as “include” and “contain” in the specification shall be interpreted as the meaning of inclusion rather than exclusive or exhaustive meaning, that is, the meaning of “including but not limited to”.

In the description of the present disclosure, it should be understood that the terms “first” and “second” are used only for description and shall not be understood as indicting or implying a relative importance. Further, in the descriptions of the present disclosure, unless otherwise stated, “plurality” has the meaning of two or more.

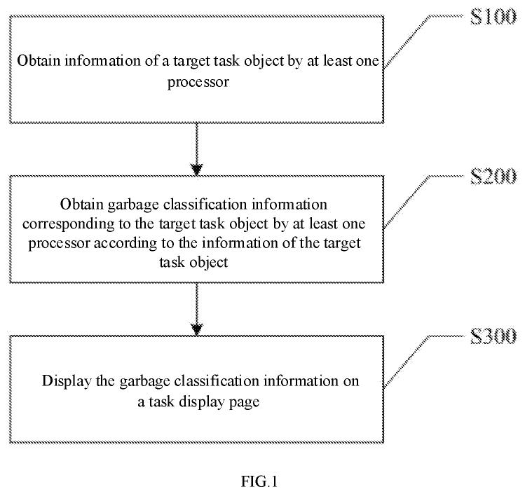

FIG. 1 is a flowchart illustrating a method of processing information according to an embodiment of the present disclosure. As shown in FIG. 1, the method of processing information in the embodiment includes the following steps.

At step S100, information of a target task object is obtained by at least one processor, where the information of the target task object includes a name and additional information of the target task object. In some examples, after a target task is generated, the information of the target task object may be obtained by at least one processor. In other examples, in response to an instruction for selecting one task object on a task object preview interface as a target task object, information of the selected target task object is obtained. With takeout as an example, in an implementation, after a takeout platform determines a takeout order, information of the takeout order (also referred to as takeout order information) is obtained by at least one processor, including name of a dish to be taken out (name of the target task object), takeout packaging information and cutlery information (additional information) and the like. In other examples, one or more dishes are selected on a dish preview interface of the takeout platform, and information of the selected dish is obtained. In this way, before placing an order, the user may obtain, in advance, a garbage possibly produced by the selected dish and its classification information.

At step S200, garbage classification information corresponding to the target task object is obtained by at least one processor according to the information of the target task object.

Different regions may have different garbage classification rules. In some examples, the information of the target task object further includes address information of the target task object (e.g. a delivery address of the takeout order). Specifically, at step S200, a corresponding garbage classification criterion is determined according to the address information of the target task object; and the garbage classification information of the target task object is determined according to the corresponding garbage classification criterion.

In some examples, the garbage classification information corresponding to the target task object is obtained by at least one processor on a user terminal according to the information of the target task object. In some examples, a pre-established garbage classification table or garbage classification model is embedded in the takeout platform installed on the user terminal, and the user terminal may determine the garbage classification information according to the information of the target task object based on the pre-established garbage classification table. The garbage classification table is established according to the information of historical task objects based on a pre-set garbage classification rule. In some examples, a plurality of garbage classification tables or garbage classification models corresponding to the garbage classification rules of different regions are embedded in the takeout platform, and a garbage classification rule of an object is determined based on the address information of the takeout order, and then a corresponding garbage classification table or garbage classification model is determined based on the garbage classification rule. In other examples, after obtaining the information of the target task object, the user terminal sends the information of the target task object to a server and receives the garbage classification information corresponding to the target task object and determined by the server. In some examples, a pre-established garbage classification table or garbage classification model is embedded in the server, and the server determines the garbage classification information based on the information of the target task object according to the pre-established garbage classification table, and then returns the garbage classification information to the user terminal.

For example, the following descriptions are made below with a Shanghai garbage classification rule as a preset garbage classification rule and a takeout order as a task object.

By performing statistics for the dishes of historical takeout orders and the garbages which finally may be produced by the dishes, the below garbage classification table can be obtained, as shown in Table (1).

TABLE 1

| Dish name | Garbages produced | Garbage classification |
|---|---|---|
| Spicy | Plastic food box | Dry garbage or recoverable after being |
| lobsterling | | washed |
| | Plastic gloves | Dry garbage |
| | Plastic packaging bag | Dry garbage |
| | Lobster shell | Wet garbage |
| Cake | Packaging paper box | Recoverables |
| | Disposable plate, | Dry garbage |
| | knife, fork or spoon | |
| | Candle | Dry garbage |
| | Cake | Wet garbage |
| Self-heating | External packaging | Dry garbage |
| hot pot | Heating bag | Harmful garbage |
| | Disposable chopsticks | Dry garbage |
| | Napkin | Dry garbage |
| | Food leftover | Wet garbage |
| . . . | . . . | . . . |

It should be understood that the garbage classification table shown in Table 1 is merely illustrative. The packaging information of different takeout sellers may be different, and the corresponding garbage classes may also be different. Therefore, the garbage classification table may also not associate the takeout dishes with the takeout packaging. A query for a garbage that may be produced by a dish may be performed based on a dish name, and a query for a garbage that may be produced by a takeout packaging may be performed based on takeout packaging information, and no limitation is made in this embodiment.

Therefore, after the takeout order information is obtained, corresponding garbage classification information may be obtained respectively according to the corresponding dish information, packaging information and cutlery information.

In other examples, the garbage classification information is determined according to the information of the target task object based on the pre-established garbage classification model. The garbage classification model is obtained based on the information of historical task objects. The following descriptions are made below with a Shanghai garbage classification rule as a preset garbage classification rule and a takeout order as a task object.

In some examples, the above garbage classification model is established based on a Logistic regression model or an artificial neural network algorithm. The dish information, the packaging information, the cutlery information of the historical takeout orders and the garbage classification results corresponding to the historical takeout orders are input as a training sample into the Logistic regression model or the artificial neural network algorithm model for training, so as to obtain the garbage classification model corresponding to the takeout orders. In some examples, according to recipe information of the dishes (raw preparation material and preparation method), the Logistic regression model or the artificial neural network algorithm model may be trained to obtain the garbage classification model. Therefore, the garbage classification model may predict raw preparation material and preparation method of the dish based on a dish name, and determine a garbage corresponding to the dish based on the raw preparation material and the preparation method, thus further improving the accuracy of the garbage classification model.

In some examples, based on the garbage classification model, determining the garbage classification information according to the information of the target task object specifically includes: inputting the information of the target task object into the garbage classification model to predict the raw material information and the preparation information corresponding to the target task object, and determining the garbage classification information according to the raw material information, the preparation information, and the additional information.

If the task object is a takeout order and the dish of the takeout order, for example, is braised chicken, the raw material is chicken nuggets and auxiliary dressings (ginger, shiitake mushroom and pepper and the like) and the preparation method is braising the chicken nuggets and the auxiliary dressings. In this case, the garbage classification information determined based on the raw material, the preparation information and the additional information includes: chicken bone: wet garbage, remaining auxiliary dressing: wet garbage, plastic packaging box: dry garbage or classified as recoverable after being washed, disposable chopsticks: dry garbage, napkin: dry garbage. For another example, if a dish of a takeout order is chicken rib rice, the raw material is chicken ribs and auxiliary dressings (flavoring sauce and the like), and the preparation method is baking the pickled chicken ribs. In this case, the garbage classification information determined based on the raw material, the preparation information and the additional information includes: food leftover: wet garbage, plastic packaging box: dry garbage or classified as recoverable after being washed, disposable chopsticks: dry garbage, napkin: dry garbage. Thus, although both the raw material of the braised chicken and the chicken rib rice is chicken, the types of the garbages produced by them are different. Therefore, by analyzing the raw material and the preparation method of the target task object, the garbage classification model can more accurately determine a garbage which may be produced by the target task object and the corresponding garbage classification information.

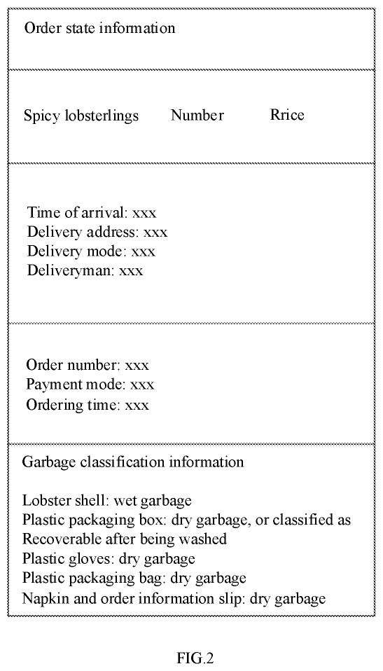

At step S300, the garbage classification information is displayed on a task display page. In some examples, after the garbage classification information is obtained, the garbage classification information is directly displayed on the task display page. As shown in FIG. 2, with a takeout order as an example, the task display page includes order state information, order detailed information, delivery information, order information, and garbage classification information. The order state information includes reached or unreached. When the order state information is in an unreached state, delivery route information is displayed at the position of the order state information. The order detailed information includes the dishes of the takeout order, dish number and price and the like. The delivery information includes time of arrival (or estimated time of arrival), delivery address, delivery mode (delivered by the takeout platform or the seller and the like) and deliveryman information and the like. The order information includes order number, payment mode and ordering time and the like. The garbage classification information is information corresponding to the garbage which may be produced, which is obtained based on the dish information of the order detailed information, the packaging information and the cutlery information and the like. For example, the garbage classification information corresponding to the spicy lobsterlings in FIG. 2 may include: lobster shell: wet garbage, plastic packaging box: dry garbage, or classified as recoverable after being washed, plastic gloves: dry garbage, plastic packaging bag: dry garbage, and napkin and order information slip: dry garbage. It is easily understood that the order display page in FIG. 2 is merely illustrative and the takeout platform may make adaptive configuration based on the existing order display page.

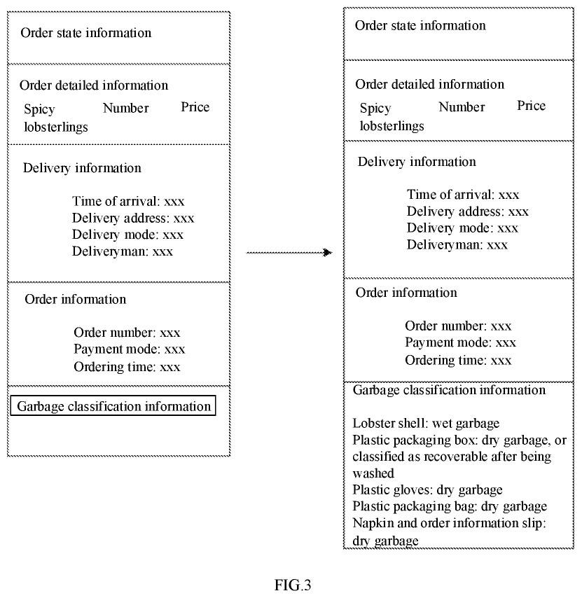

In other examples, after the garbage classification information is obtained, in response to a garbage classification display instruction, the garbage classification information is displayed on the task display page. As shown in FIG. 3, with a takeout order as an example, the task display page includes order state information, order detailed information, delivery information, order information and “garbage classification information” add-in. After an operation for the “garbage classification information” add-in is received (that is, a garbage classification display instruction is received), the corresponding garbage classification information is displayed on the task display page. The detailed content displayed on the task display page is similar to that in FIG. 2 and will not be repeated herein.

In this embodiment, the task display page includes all pages relating to the target task or other tasks, for example, an order display page after the target task is generated or a task object browse interface before the target task is generated, and the like. It should be understood that the display manner of the garbage classification information is not limited in this embodiment, and it is stilled considered to be within the scope of protection of this embodiment that any garbage classification information corresponding to the target task information is obtained based on the target task information and displayed on a terminal page relating to the target task. For example, after the operation for the “garbage classification information” add-in is received, an independent display box may be popped up to display the obtained garbage classification information, or, after the operation for the “garbage classification information” add-in is received, a jump is made to the garbage classification display page to display the obtained garbage classification information and the like.

In this embodiment, after an instruction for generating a target task is received, the information of the target task object is obtained, and the garbage classification information corresponding to the target task object is obtained based on the information of the target task object, and then the garbage classification information is displayed on the task display page. Therefore, a user may be directed to carry out garbage classification, thus improving the accuracy of garbage identification and classification.

In some examples, the method of processing information in this embodiment may further include: receiving garbage classification feedback information by at least one processor; updating the garbage classification table based on the garbage classification feedback information, and/or, adjusting an algorithm parameter of the garbage classification model based on the garbage classification feedback information. In this way, the accuracy of the garbage classification can be further improved, so as to better direct the user to carry out garbage classification. For example, if a dish corresponding to a takeout order is a clam soup with bean vermicelli, its raw material includes clam and shrimp and the like. It is possible that no corresponding garbage class corresponding to the shrimp of the clam soup with bean vermicelli is obtained by querying the garbage classification table. Therefore, data of a garbage class corresponding to the shrimp is not present in the displayed garbage classification information. Hence, a garbage which may be produced by the clam soup with bean vermicelli is updated based on the garbage classification feedback information of the user, so as to further improve the accuracy of the garbage classification of the dishes. In some examples, shrimp is not present in the raw material of the clam soup with bean vermicelli predicted by the garbage classification model, and thus, data of a garbage class corresponding to the shrimp is not present in the displayed garbage classification information. The garbage classification model may be re-trained using the garbage classification feedback information of the user, so as to adjust an algorithm parameter of the above garbage classification model, thereby further improving the accuracy of garbage classification of the dishes.

In some examples, the method of processing information in this embodiment may further include: determining a resource cost parameter corresponding to a garbage produced by the target task object; displaying the resource cost parameter on the task display page. In some examples, the resource cost parameter may include a resource required to process the garbage produced by the target task object and the like. With a takeout order as an example, the resource cost parameter may include a resource required for processing the garbage produced by the takeout, and/or, a resource saved by unselecting cutlery and the like, so as to direct a user to reduce use of packagings with serious pollution or use of disposable cutlery. Further, in some examples, when the resource cost parameter is smaller than a preset threshold, prizes such as score, bonus or energy or the like may be given to the user, to further encourage the user to reduce use of packagings with serious pollution or use of disposable cutlery.

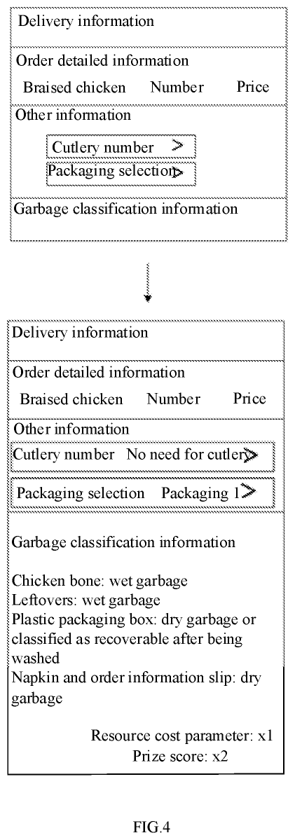

As shown in FIG. 4, the current task display page is an order generation page including delivery information, order detailed information, other information and garbage classification information, where the other information includes a “cutlery number” add-in, and a “packaging selection” add-in. The user may select one of options such as “no need for cutlery”, “one set” and “two sets” and the like by clicking on the “cutlery number” add-in. In some examples, information such as giving a preset number of scores may be displayed after the option “no need for cutlery”. The user may select a packaging type corresponding to a takeout by clicking on the “packaging selection” add-in, where the packaging type may include packaging information provided by the seller and preset unified packaging information and the like. In some examples, after each packaging type, information such as the resource cost parameter corresponding to the packaging may be displayed. As shown in FIG. 4, the user selects “no need for cutlery” and “packaging 1 (plastic packaging box)”. After the cutlery and the packaging are selected, the garbage classification information may be determined based on the dish information, the cutlery information and the packaging information, and then the resource cost parameter x1 corresponding to the takeout order may be calculated based on the determined garbage classification information, and then a prize score x2 may be determined based on the resource cost parameter x1. As a result, before order payment, the user may be directed to select more environment-friendly cutlery and packaging. It should be understood that the task display page shown in FIG. 4 is merely illustrative and is not limited in this embodiment.

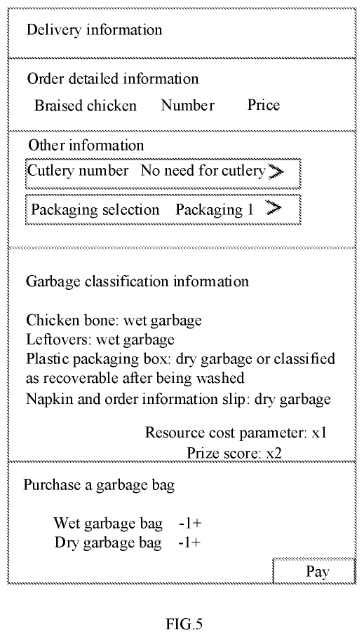

In some examples, the method of processing information in this embodiment may further include: determining corresponding garbage bag information based on the obtained garbage classification information, and displaying the garbage bag information on the order generation page. As shown in FIG. 5, the order generation page includes a part for purchasing a garbage bag. After the garbage classification information is determined, based on the garbage classification information, the garbage bag information desired by the user is displayed for the user to purchase. Of course, the user may also select not to purchase the garbage bag. In some examples, in the part for selecting a garbage bag, all types of garbage bags may be displayed for the user to purchase, which is not limited in this embodiment.

In some examples, after the user places an order and makes a payment, the task display page displays the garbage classification information of the current order and the corresponding resource cost parameter and so on, which may be used to remind the user of the resource cost parameter in this order, thus helping to direct the user to select more environment-friendly cutlery and packaging in a subsequent order.

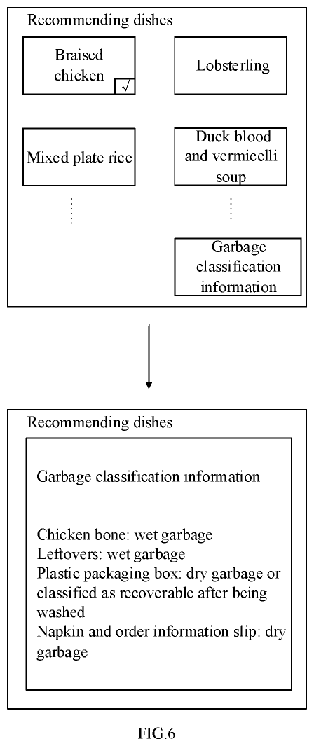

The task display pages shown in FIGS. 2 to 5 are all task display pages after an order is placed. It should be understood that the garbage classification information in this embodiment may also be displayed before an order is placed. As shown in FIG. 6, on the dish display page of the takeout platform, a desired dish is selected and the “garbage classification information” add-in is operated. In this case, the garbage classification information corresponding to the selected dish is displayed on the current task interface, or on a floating window, or a jump is made to a new page to display the garbage classification information corresponding to the selected dish. Therefore, the user may select a dish based on the garbage classification information. For example, if a garbage possibly produced by the dish currently selected is difficult to treat, the user may select another dish and so on, thus improving experiences for the user.

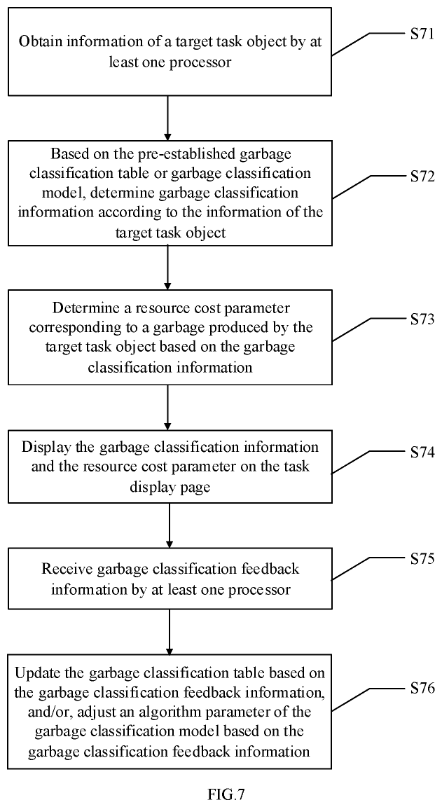

FIG. 7 is a flowchart illustrating another method of processing information according to an embodiment of the present disclosure. In this embodiment, a pre-established garbage classification table or garbage classification model is embedded in the takeout platform of the user terminal, that is, the garbage classification information is determined at the user terminal. As shown in FIG. 7, the method of processing information according to an embodiment of the present disclosure includes the following steps.

At step S71, information of a target task object is obtained by at least one processor, where the information of the target task object includes a name and additional information of the target task object. In some examples, after a target task is generated, the information of the target task object may be obtained by at least one processor. In other examples, in response to an instruction for selecting one task object on a task object preview interface as the target task object, the information of the selected target task object is obtained. With a takeout as an example, after the takeout platform confirms an order or one or more dishes are selected on the dish preview interface, the takeout order information may be obtained by at least one processor, including dish name of the takeout (name of the target task object), takeout packaging information and cutlery information (additional information) and the like.

At step S72, based on the pre-established garbage classification table or garbage classification model, garbage classification information is determined according to the information of the target task object. The garbage classification table is established based on a preset garbage classification rule according to information of historical task objects, and the garbage classification model is obtained through training according to the information of the historical task objects. The manner in which the garbage classification table and the garbage classification model are established is similar to that in the method of processing information as shown in FIG. 1 and thus will not be repeated herein.

At step S73, a resource cost parameter corresponding to a garbage produced by the target task object is determined based on the garbage classification information. In some examples, the resource cost parameter may include a resource required to process the garbage produced by the target task object and the like. With a takeout order as an example, the resource cost parameter may include a resource required for processing the garbage produced by the takeout, and/or, a resource saved by unselecting cutlery and the like, so as to direct a user to reduce use of packagings with serious pollution or use of disposable cutlery. Further, in some examples, when the resource cost parameter is smaller than a preset threshold, prizes such as score, bonus or energy or the like may be given to the user, to further encourage the user to reduce use of packagings with serious pollution or use of disposable cutlery.

At step S74, the garbage classification information and the resource cost parameter are displayed on the task display page. In some examples, after the garbage classification information is obtained, the garbage classification information may be directly displayed on the task display page. In other examples, after the garbage classification information is obtained, in response to a garbage classification display instruction, the garbage classification information is displayed on the task display page.

At step S75, garbage classification feedback information is received by at least one processor.

At step S76, the garbage classification table is updated based on the garbage classification feedback information, and/or, an algorithm parameter of the garbage classification model is adjusted based on the garbage classification feedback information.

It is easily understood that the steps S75 to S76 are performed after the user sends the garbage classification feedback information; these steps may be performed before steps S71 to S74, or after steps S71 to S74, and a task object involved in the steps S75 to S76 may be a target task object or a historical task object. The above is not limited herein.

In this embodiment, after an instruction for generating a target task is received, the information of the target task object is obtained, and the garbage classification information corresponding to the target task object is obtained based on the information of the target task object, and then the corresponding resource cost parameter is determined based on the garbage classification information and then the garbage classification information and the resource cost parameter are displayed on the task display page. At the same time, the garbage classification table or the garbage classification model may be updated using the garbage classification feedback information fed back by the user. Thus, the user may be directed to carry out garbage classification, thus improving the accuracy of garbage identification and classification.

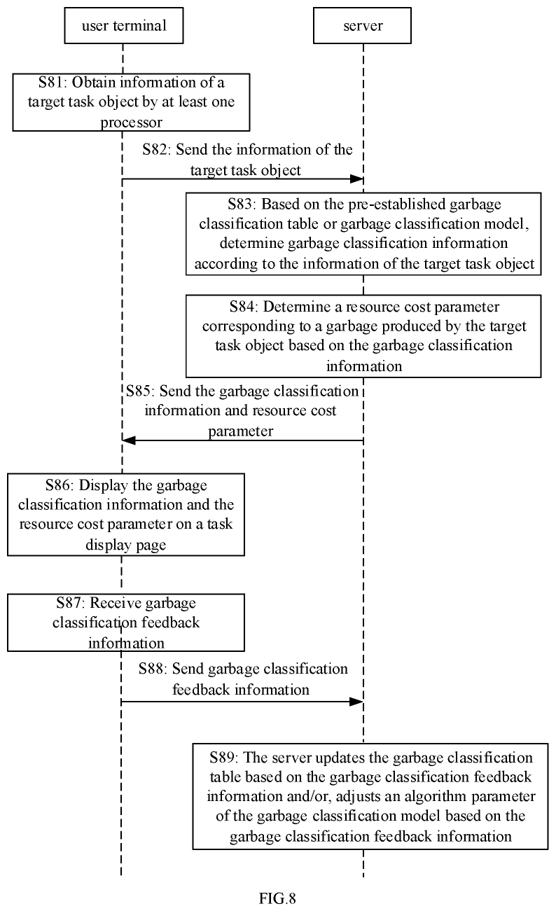

FIG. 8 is a flowchart illustrating yet another method of processing information according to an embodiment of the present disclosure. In this embodiment, a pre-established garbage classification table or garbage classification model is embedded in a server, that is, the garbage classification information is determined at the server. As shown in FIG. 8, the method of processing information in this embodiment includes the following steps.

At step S81, a user terminal obtains information of a target task object by at least one processor, where the information of the target task object includes a name and additional information of the target task object. In some examples, after a target task is generated, the information of the target task object may be obtained by at least one processor. In other examples, in response to an instruction for selecting one task object on a task object preview interface as the target task object, the information of the selected target task object is obtained. With a takeout as an example, after the takeout platform determines an order or one or more dishes are selected on the dish preview interface, the takeout order information may be obtained by at least one processor, including dish name of the takeout (name of the target task object), takeout packaging information and cutlery information (additional information) and the like.

At step S82, the user terminal sends the information of the target task object to the server.

At step 83, based on the pre-established garbage classification table or garbage classification model, the server determines garbage classification information according to the information of the target task object, where the garbage classification table is established based on a preset garbage classification rule according to information of historical task objects, and the garbage classification model is obtained through training according to the information of the historical task objects. The manner in which the garbage classification table and the garbage classification model are established is similar to that in the method of processing information as shown in FIG. 1 and thus will not be repeated herein.

At step S84, the server determines a resource cost parameter corresponding to a garbage produced by the target task object based on the garbage classification information. In some examples, the resource cost parameter may include a resource required to process the garbage produced by the target task object and the like. With a takeout order as an example, the resource cost parameter may include a resource required for processing the garbage produced by the takeout, and/or, a resource saved by unselecting cutlery and the like, so as to direct a user to reduce use of packagings with serious pollution or use of disposable cutlery. Further, in some examples, when the resource cost parameter is smaller than a preset threshold, prizes such as score, bonus or energy or the like may be given to the user, to further encourage the user to reduce use of packagings with serious pollution or use of disposable cutlery.

At step S85, the server sends the obtained garbage classification information and resource cost parameter to the user terminal.

At step S86, the user terminal displays the garbage classification information and the resource cost parameter on a task display page. In some examples, after the garbage classification information is obtained, the garbage classification information may be directly displayed on the task display page. In other examples, after the garbage classification information is obtained, in response to a garbage classification display instruction, the garbage classification information is displayed on the task display page.

At step S87, the user terminal receives garbage classification feedback information.

At step S88, the user terminal sends the received garbage classification feedback information to the server.

At step S89, the server updates the garbage classification table based on the garbage classification feedback information and/or, adjusts an algorithm parameter of the garbage classification model based on the garbage classification feedback information.

It is easily understood that the steps S88 to S89 are performed after the user sends the garbage classification feedback information; these steps may be performed before steps S81 to S87, or after steps S81 to S87, and a task object involved in the steps S88 to S89 may be a target task object or a historical task object. The above is not limited herein.

In this embodiment, after an instruction for generating a target task is received, the user terminal obtains the information of the target task object, and sends the information of the target task object to the server such that the server determines the garbage classification information based on the information of the target task object, and then determines the corresponding resource cost parameter based on the garbage classification information, and then sends the garbage classification information and the resource cost parameter to the terminal. In this case, the user terminal displays the garbage classification information and the resource cost parameter on the task display page. At the same time, the user terminal sends the obtained garbage classification feedback information to the server such that the server updates the garbage classification table or garbage classification model based on the garbage classification feedback information. Therefore, the user may be directed to carry out garbage classification, thus improving the accuracy of garbage identification and classification and reducing the running burden of the user terminal at the same time.

FIG. 9 is a schematic diagram illustrating an apparatus for processing information according to an embodiment of the present disclosure. As shown in FIG. 9, the apparatus for processing information according to the embodiment includes a target task object information obtaining unit 91, a garbage classification information obtaining unit 92 and a displaying unit 93.

The target task object information obtaining unit 91 is configured to obtain, by at least one processor, information of a target task object, where the information of the target task object includes a name and additional information of the target task object. The garbage classification information obtaining unit 92 is configured to obtain, by at least one processor, garbage classification information corresponding to the target task object according to the information of the target task object. The displaying unit 93 is configured to display the garbage classification information on a task display page.

In this embodiment, after an instruction for generating a target task is received, information of a target task object is obtained, and garbage classification information corresponding to the target task object is obtained according to the information of the target task object, and then the garbage classification information is displayed on a task display page. Therefore, a user may be directed to carry out garbage classification, thus improving an accuracy of the garbage identification and classification.

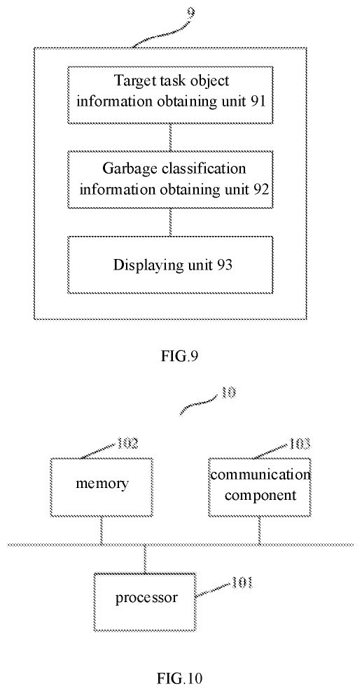

FIG. 10 is a schematic diagram illustrating an electronic device according to an embodiment of the present disclosure. In this embodiment, the electronic device 10 includes a server and a terminal and the like. As shown in FIG. 10, the electronic device 10 includes: at least one processor 101; a memory 102 in communication connection with the at least one memory 101; and a communication component 103 in communication connection with a scanning apparatus. The communication component 103 is controlled by the processor 101 to receive and send data. The memory 102 stores instructions that can be executed by at least one processor 101 to perform the steps of:
obtaining, by at least one processor, information of a target task object, where the information of the target task object includes a name and additional information of the target task object;
obtaining, by at least one processor, garbage classification information corresponding to the target task object according to the information of the target task object;
displaying the garbage classification information on a task display page.

In some examples, displaying the garbage classification information on the task display page includes:
in response to a garbage classification display instruction, displaying the garbage classification information on the task display page.

In some examples, obtaining, by at least one processor, the garbage classification information corresponding to the target task object according to the information of the target task object includes:
based on a pre-established garbage classification table or garbage classification model, determining the garbage classification information according to the information of the target task object;
where the garbage classification table is established based on a preset garbage classification rule according to information of historical task objects, and the garbage classification model is obtained through training according to the information of the historical task objects.

In some examples, based on the garbage classification model, determining the garbage classification information according to the information of the target task object includes:
inputting the information of the target task object into the garbage classification model to obtain raw material information and preparation information corresponding to the target task object;
according to the raw material information, the preparation information and the additional information, determining the garbage classification information.

In some examples, obtaining, by at least one processor, the garbage classification information corresponding to the target task object according to the information of the target task object includes:
sending the information of the target task object;
receiving the garbage classification information determined by a server.

In some examples, the instructions are executed by at least one processor 101 to further perform the steps of:
receiving, by at least one processor, garbage classification feedback information;
updating the garbage classification table based on the garbage classification feedback information, and/or, adjusting an algorithm parameter of the garbage classification model based on the garbage classification feedback information.

In some examples, the instructions are executed by at least one processor 101 to further perform the steps of:
determining a resource cost parameter corresponding to a garbage produced by the target task object;
displaying the resource cost parameter in the task display page.

In some examples, the information of the target task object further includes address information of the target task object;
obtaining, by at least one processor, the garbage classification information corresponding to the target task object according to the information of the target task object includes:
determining a corresponding garbage classification criterion according to the address information;
determining the garbage classification information of the target task object according to the garbage classification criterion.

Specifically, the electronic device includes one or more processors 101 and a memory 102. FIG. 10 illustrates one processor 101 as an example. The processor 101 and the memory 102 may be connected mutually via a bus or another way. FIG. 10 shows a bus connection as an example. The memory 102, as a non-volatile computer readable storage medium, may be used to store non-volatile software programs, non-volatile computer executable programs and modules. The processor 101 runs the non-volatile software programs, instructions and modules stored in the memory 102 to implement various functional applications and data processings of the device, thus achieving the method of processing information.

The memory 102 may include a program storage area and a data storage area, where the program storage area may store operating system, and application programs required by at least one function; and the data storage area may store option list and the like. Furthermore, the memory 102 may include a high speed random access memory or a non-volatile memory, for example, at least one magnetic disk storage device, flash storage device, or other non-volatile solid state storage devices. In some embodiments, the memory 102 may optionally include a memory disposed remotely relative to the processor 101. These remote memories may be connected to an external device through network. The instances of the above network may include but not limited to internet, intranet, local area network and mobile communication network and a combination thereof.

One or more modules are stored in the memory 102 such that the one or more modules are executed by one or more processors 101 to implement the method of processing information according to any one of the above method embodiments.

The above product may perform the method provided by the embodiments of the present disclosure and have corresponding functional modules for performing the method and beneficial effects. Those technical details not fully described in this embodiment may be referred to the method provided by the embodiments of the present disclosure.

In the embodiments of the present disclosure, after an instruction for generating a target task is received, information of a target task object is obtained, and garbage classification information corresponding to the target task object is obtained according to the information of the target task object, and then the garbage classification information is displayed on a task display page. Therefore, a user may be directed to carry out garbage classification, thus improving an accuracy of the garbage identification and classification.

Another embodiment of the present disclosure relates to a non-volatile storage medium configured to store computer readable programs, where the computer readable programs may be used for a computer to implement part or all of the above method embodiments.

Therefore, those skilled in the art may understand that part or all of the steps of the method for implementing the above embodiments may be performed by instructing relevant hardware through a program. The program is stored in one storage medium and includes several instructions to enable one device (single-chip computer or chip and the like) or a processor to perform part or all of the steps of the method for implementing the embodiments of the present disclosure. The above storage medium includes a USB disk, a mobile hard disk, a Read-Only Memory (ROM), a Random Access Memory (RAM), a magnetic diskette or a compact disk and various media which may store program codes.

The above descriptions are made to the preferred embodiments of the present disclosure and shall not be intended to limit the present disclosure. Those skilled in the art may make various changes or modifications to the present disclosure. Any changes, equivalent substitutions, and improvements made within the spirit and principle of the present disclosure shall all fall within the scope of protection of the present disclosure.

What is claimed is:

1. A method of processing information, comprising:
obtaining, by at least one processor, information of a target task object, wherein the information of the target task object comprises a name and additional information of the target task object;
obtaining, by at least one processor, garbage classification information corresponding to the target task object according to the information of the target task object;
displaying the garbage classification information on a task display page corresponding to the information of the target task object;
wherein obtaining, by at least one processor, the information of the target task object comprises one of:
obtaining, by at least one processor, the information of the target task object after a target task is generated, or
in response to an instruction for selecting a task object on a task object preview interface as a target task object, obtaining information of the selected target task object
wherein the target task represents a service order generated based on a takeout platform, and the task object represents a dish provided by the takeout platform.

2. The method of claim 1, wherein displaying the garbage classification information on the task display page corresponding to the information of the target task object comprises:
in response to a garbage classification display instruction, displaying the garbage classification information on the task display page.

3. The method of claim 1, wherein obtaining, by at least one processor, the garbage classification information corresponding to the target task object according to the information of the target task object comprises:
based on a pre-established garbage classification table or garbage classification model, determining the garbage classification information according to the information of the target task object;
wherein the garbage classification table is established based on a preset garbage classification rule according to information of historical task objects, and the garbage classification model is obtained through training according to the information of the historical task objects.

4. The method of claim 3, wherein based on the garbage classification model, determining the garbage classification information according to the information of the target task object comprises:
inputting the information of the target task object into the garbage classification model to obtain raw material information and preparation information corresponding to the target task object;
according to the raw material information, the preparation information and the additional information, determining the garbage classification information.

5. The method of claim 1, wherein obtaining, by at least one processor, the garbage classification information corresponding to the target task object according to the information of the target task object comprises:
sending the information of the target task object;
receiving the garbage classification information determined by a server.

6. The method of claim 3, further comprising:
receiving, by at least one processor, garbage classification feedback information;
updating the garbage classification table based on the garbage classification feedback information, and/or, adjusting an algorithm parameter of the garbage classification model based on the garbage classification feedback information.

7. The method of claim 1, further comprising:
determining a resource cost parameter corresponding to a garbage produced by the target task object;
displaying the resource cost parameter in the task display page.

8. The method of claim 1, wherein the information of the target task object further comprises address information of the target task object;
obtaining, by at least one processor, the garbage classification information corresponding to the target task object according to the information of the target task object comprises:
determining a corresponding garbage classification criterion according to the address information;
determining the garbage classification information of the target task object according to the garbage classification criterion.

9. (canceled)

10. An electronic device, comprising a memory and a processor, wherein the memory is configured to store one or more computer program instructions, and the one or more computer program instructions are executed by the processor to perform the steps of:
obtaining, by at least one processor, information of a target task object, wherein the information of the target task object comprises a name and additional information of the target task object;
obtaining, by at least one processor, garbage classification information corresponding to the target task object according to the information of the target task object;
displaying the garbage classification information on a task display page corresponding to the information of the target task object;
wherein obtaining, by at least one processor, the information of the target task object comprises one of:
obtaining, by at least one processor, the information of the target task object after a target task is generated, or
in response to an instruction for selecting a task object on a task object preview interface as a target task object, obtaining information of the selected target task object;
wherein the target task represents a service order generated based on a takeout platform, and the task object represents a dish provided by the takeout platform.

11. The electronic device of claim 10, wherein displaying the garbage classification information on the task display page corresponding to the information of the target task object comprises:
in response to a garbage classification display instruction, displaying the garbage classification information on the task display page.

12. The electronic device of claim 10, wherein obtaining, by at least one processor, the garbage classification information corresponding to the target task object according to the information of the target task object comprises:
based on a pre-established garbage classification table or garbage classification model, determining the garbage classification information according to the information of the target task object;
wherein the garbage classification table is established based on a preset garbage classification rule according to information of historical task objects, and the garbage classification model is obtained through training according to the information of the historical task objects.

13. The electronic device of claim 12, wherein based on the garbage classification model, determining the garbage classification information according to the information of the target task object comprises:
inputting the information of the target task object into the garbage classification model to obtain raw material information and preparation information corresponding to the target task object;
according to the raw material information, the preparation information and the additional information, determining the garbage classification information.

14. The electronic device of claim 10, wherein obtaining, by at least one processor, the garbage classification information corresponding to the target task object according to the information of the target task object comprises:
sending the information of the target task object;
receiving the garbage classification information determined by a server.

15. The electronic device of claim 12, wherein the one or more computer program instructions are executed by the processor to further perform the steps of:
receiving, by at least one processor, garbage classification feedback information;
updating the garbage classification table based on the garbage classification feedback information, and/or, adjusting an algorithm parameter of the garbage classification model based on the garbage classification feedback information.

16. The electronic device of claim 10, wherein the one or more computer program instructions are executed by the processor to further perform the steps of:
determining a resource cost parameter corresponding to a garbage produced by the target task object;
displaying the resource cost parameter in the task display page.

17. The electronic device of claim 10, wherein the information of the target task object further comprises address information of the target task object;
obtaining, by at least one processor, the garbage classification information corresponding to the target task object according to the information of the target task object comprises:
determining a corresponding garbage classification criterion according to the address information;
determining the garbage classification information of the target task object according to the garbage classification criterion.

18. A computer readable storage medium, storing one or more computer program instructions thereon, wherein the computer program instruction is executed by a processor to implement the method according to claim 1.
